(19) United States
(12) Patent Application Publication
(10) Pub. No.: US 2004/0012865 A1
(43) Pub. Date: Jan. 22, 2004

(54) Spin-stabilized film mirror and its application in space

(76) Inventor: Shangli Huang, Nanchang City (CN)

Correspondence Address: Greenberg Traurig, 2450 Colorado Avenue, suite 400E, Santa Monica, CA, 90404, US

(21) Appl. No.: 10/363,578

(22) PCT Filed: Sep. 5, 2001
(86) PCT No.: PCT/CN01/01342

(30) Foreign Application Priority Data
Sep. 7, 2000 (CN) 00125958.X

(51) Int. Cl. G02B 5/10

(52) U.S. Cl. 359/853

(57) ABSTRACT

The spin-stabilized film mirror consists of reflecting film, cables, and the weights and load connected therewith. The film mirror surface is a curved face of revolution. The edge of the film is connected by cables to multiple weights at the periphery of the mirror face, and the weights in turn is connected to the load, which is located at the position of mirror axis. The film mirror stretches out in space and maintains its prefabricated form of curved face of revolution by spin centrifugal pull. The mass of the film mirror is less than 40 g per square meter, capable of doubling and redoubling the generating power of solar energy equipment on a spacecraft, reducing significantly the weight of the system. Film mirrors of large scale is capable of collecting solar energy of tens of square kilometers in space, paving the way for large space solar power station.

This invention relates to the focus mirrors of large diameters or more precisely spin-stabilized film mirrors and their application in space.

Using the focus of paraboloid mirror to collect solar energy is one of the traditional ways. But current various paraboloid mirrors of large diameters are difficult to be widely used because of their clumsy structure and high prices. In order to reduce structure weight, utility model patent “Negative Pressure Reflecting Film Solar Cooker” (patent number 91206710) published a design of making concave mirror by using reflecting film. Since this method needs a sealed capsule to keep negative pressure, it is difficult to make paraboloids of large diameters.

Solar energy is an exhaustless clean energy source, but its largest limitation is the lower energy density. If it is capable to collect solar energy on large areas with a very low cost, the limit in using solar energy in large scale can be broken through. The purpose of this invention is to produce film mirrors of large diameters by using very little materials, and to provide method for the film to stretch out in space so as to collect solar energy on large areas in space for generating power or supplying heat with very low cost. In addition, the film mirror can also be used as antenna and solar sail for spacecraft.

The spin-stabilized film mirror is made of film material of extremely thin and extremely soft but hard to be drawn. The film is coated or bonded with a layer of metal reflecting film, and is preformed into required curve surface with its peripheral edge connected to cables and weights. The function of the weights is to help the film mirror to stretch out and keep stable under spin condition. The weights are connected by control cables to the load, which may be a solar power generation system, a satellite, a space station, or a solar energy rocket, located at the axis of the curved surface. The load or the transmission on the load can drive the film mirror spin and stretch out. The spin axis points toward the sun. This gives an orientation to the film mirror against the sun and makes the flexible film mirror maintain a form of standard curved surface of revolution. Solar energy absorbers are installed on the load and at the focus point of the mirror.

Spin-stabilized film mirrors can be divided into two types: one type is concave film mirror; the other is circular film mirror.

The form of the mirror surface of a concave mirror can be a paraboloid of revolution, a spherical surface, or other curved surface of revolution. The focal point of a paraboloid concave film mirror is generally designed at the vicinity of mirror mouth plane. Suppose the paraboloid of revolution is formed by a quadratic curve Y=KX² revolving around Y axis, and if the diameter of the mirror mouth is a and let K=¹/a, the focal point of this paraboloid of revolution is at the center of the mirror mouth plane; if K>¹/a, the focal point is at the inner side of the mirror mouth plane; if K<¹/a, the focal point is at the outer side of the mirror mouth plane.

The other type is circular film mirrors, of which the form can be a circular conical surface or a circular arc surface. The generating line (a circular curved surface is deemed to have been formed by a generating line revolving around the central axis) of a circular conical surface is a strait line with a included angle of 45° between the line and the central axis. The generating line of a circular arc surface is an arc line protruding outward to concentrate the collected sunrays.

There are two ways of connecting the mouth of the film mirror and the load.

One connection method is that the edge of the mirror mouth stretches into a plane, which is connected to a plane polygon formed by cables and weights. The weights are located at the vertexes of the polygon. The flexible film mirror stretches out in space and spins. The spin produces tension towards periphery in the film mirror and thus to maintain a form of revolutionary curved surface of the film mirror. The load is connected by control cables of light weight and high strength to the weights at the edge of mirror mouth and spins in synchronism with the spinning mirror surface; or a circular ring can be mounted on the load (the central axis of the circular ring coincides with the axis of the mirror), and the control cables are connected onto the circular ring, the circular ring spins in synchronism with the mirror surface, while the load is still relative to the circular ring. Cable adjusting device and control rod are provided on the load or on the circular ring.

The other way of connecting mirror mouth with the load is to connect the edge of mirror mouth directly with the weights, which in turn are connected by control cables to the load or the circular ring on the load. Adjust precisely the lengths of the control cables to make the revolution radius of the weights around the central axis equals the radius of mirror mouth. (If the control cables are too short, the mirror mouth will form a petal; and if too long, will tend to be a polygon.)

The load of the circular film mirror penetrates the front and back mirror-mouth planes. The weights at the peripheries of the front and back mirror-mouths are connected by control cables to two circular rings respectively at the exterior side of the two mirror-mouth planes. The circular rings drive mirror to spin and this maintains the circular revolutionary curved surface of the film mirror.

The two methods for mirror-mouth connection and fixing combining with the different forms of mirror surface above can form multi kinds of spin-stabilized film mirrors.

The weights at the periphery of the film mirror can be various forms, such as spherical, conic, disk type, bar form, etc., even can be equipment such as a rocket.

Large concave film mirrors with a mouth diameter of hundreds even thousands of meters can be stretched and driven to spin in planes perpendicular to sunrays by the pulling of a number of remote controlled small rockets carried by the load. After the film mirror reaches preset rotation velocity, the rockets stop jetting, and the film mirror spins by inertia. The tension from spin and the light pressure of the sunrays make the film maintain the form of a concave mirror.

Film mirrors of smaller diameters are stretched by centrifugal pull force from the spin of load or circular ring. The spin axis should point towards the sun.

The sunrays focussed by the film mirror can be used in gallium arsenide solar cells to produce electricity. (The gallium arsenide solar cells are laid on the surface of the solar energy absorbers and provided in side with thermal siphon cooling system, which transfers heat to the thermal radiation plates.) If thermal power generation is used, the solar energy absorbers are used as a solar energy boiler. The two methods for power generation can be combined to raise the overall efficiency for power generation. The focussed solar heat can also be used as a heat source for space factory.

The spin-stabilized film mirror can concentrate solar radiation strength for tens to hundreds times, while the cost is very low (because the weight of the film mirror is very light and the folding volume of the mirror is very small, and these facilitate launching into orbit). It can increase dramatically power generation per unit mass and thus provides adequate electricity for spacecraft and reduces launching cost.

The solar energy power generation system of the spin-stabilized film mirror can be separated from the spacecraft, more than tens or hundreds of meters apart and connected in between with electric cable. The film mirror possesses a very large area and faces perpendicular to sun rays. Under long time action of the light pressure, the solar energy power generation system roves at the back side of the spacecraft towards the sun, forming a mooring type of solar energy power generation station. (It works at the high orbit around earth. Since the light pressure is very stable, this type of mooring solar energy power station is very stable and reliable.) A mooring solar energy power station can separate a large spacecraft with its power supply system, facilitating design and construction and reducing cost. By using film mirror, series of solar energy power generation systems can be produced to meet the requirements of spacecraft on different powers.

Concave film mirror of huge areas can be used to build space power stations of large scales for transmission of power to remote spacecraft or the earth.

The spin-stabilized film mirror can be used as large radio antenna (at the focal point of the mirror, there will be mounted a waveguide assembly or other signal feed equipment). This kind of antenna possess extremely lightweight and superior directivity. Large spin-stabilized film mirrors can also be used as solar sail, of which the mirror surface can be concave or plane.

In the following, detailed descriptions are given to this invention in combination with attached figures and examples of practical application.

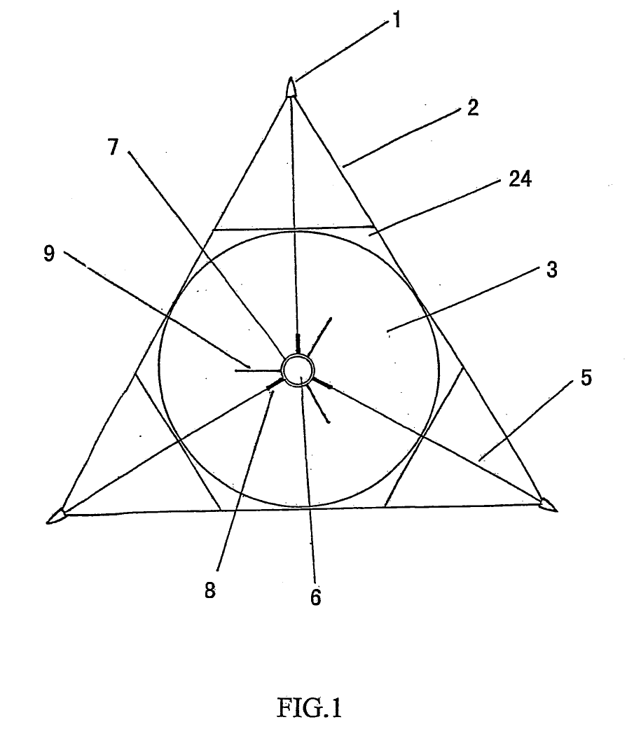

FIG. 1 Large Film Concave Mirror Stretched by Three Rockets (Front View)

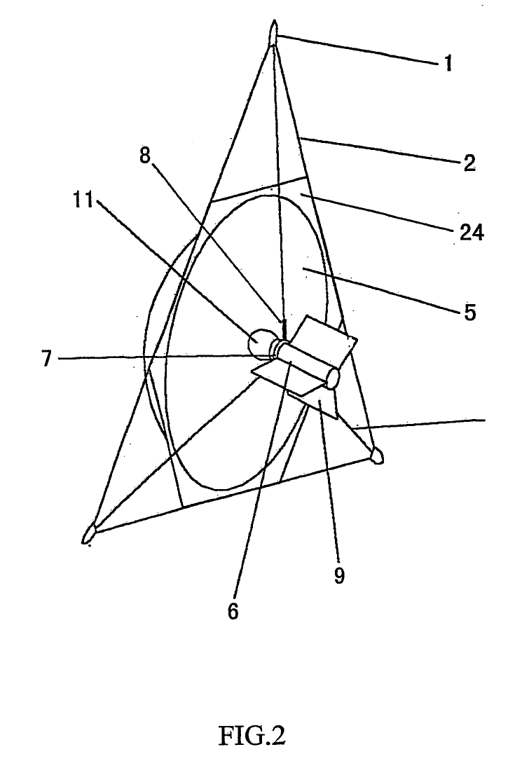

FIG. 2 Large Film Concave Mirror Stretched by Three Rockets (Three Dimensional Schematic Diagram)

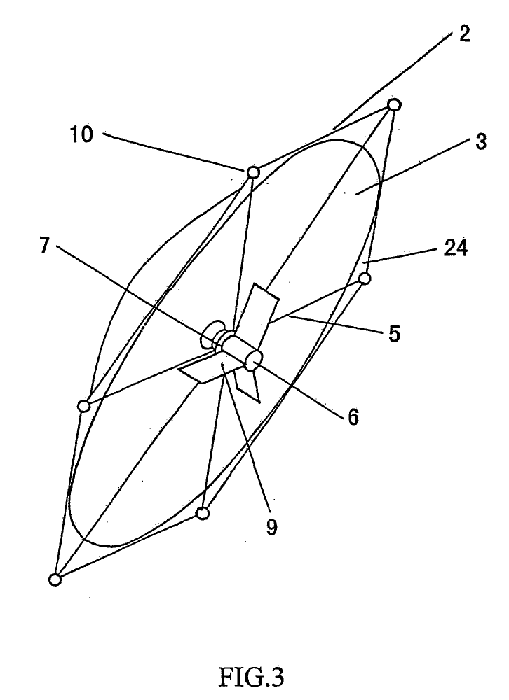

FIG. 3 Spin-stretched Film Concave Mirror (Three Dimensional Schematic Diagram)

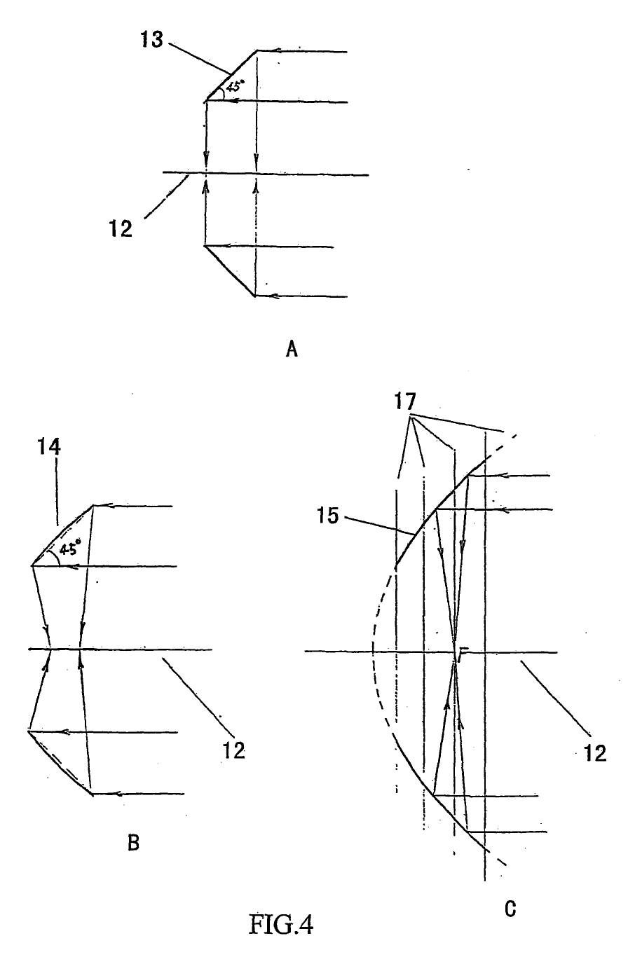

FIG. 4 Sectional Drawing and Light Path Schematic Diagram for Several Ring Form Mirrors

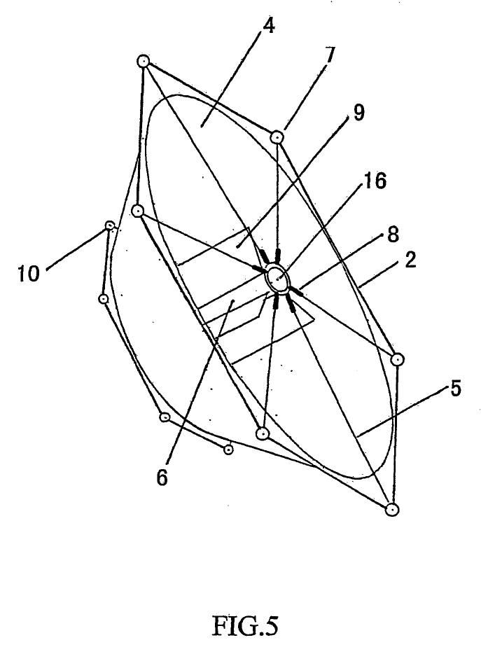

FIG. 5 Ring Form Mirrors with Polygon Frame (Three Dimensional Schematic Diagram)

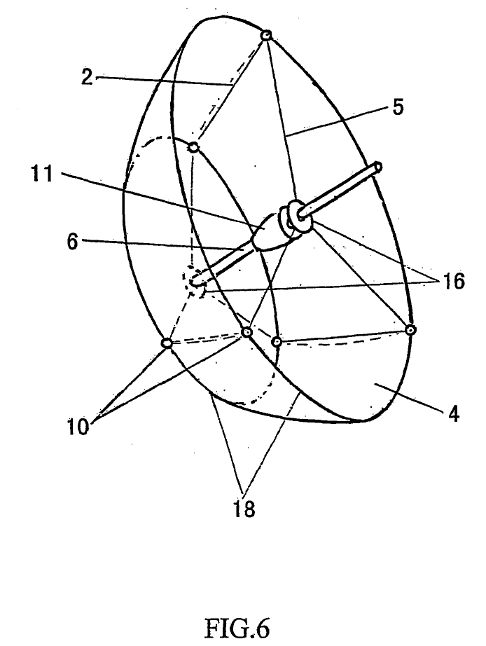

FIG. 6 Ring Form Mirrors without Frame (Three Dimensional Schematic Diagram)

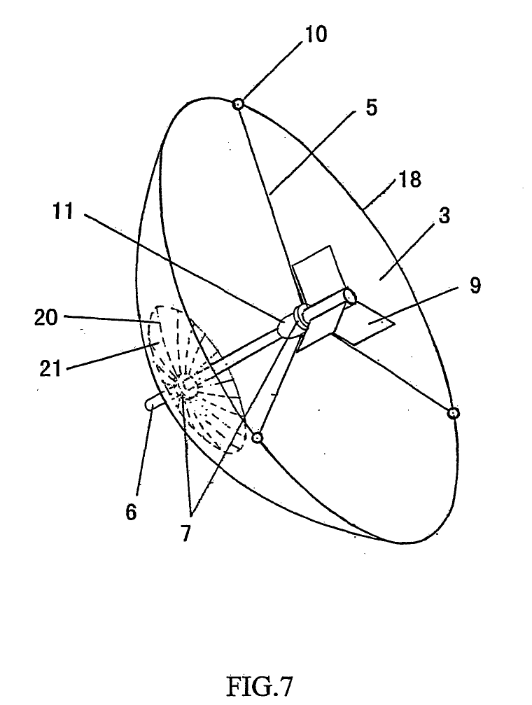

FIG. 7 Concave Mirrors with Umbrella Form of Bottom (Three Dimensional Schematic Diagram)

### PREFERRED EMBODIMENT 1

Large Film Concave Mirror Stretched by Rockets

As shown in FIG. 1 and FIG. 2, three small remote controlled rockets (1) are connected with cables (2) into a regular triangle. The edge of the film concave mirror is stretched into a plane regular hexagon, of which three sides coincide with the three sides of the regular triangle respectively. In the space of the incircle of the regular hexagon, the film is the form of paraboloid of revolution (3), of which on concave surface there is the reflecting layer. Outside the incircle, part (24) of the film is a plane film without reflection layer. The three rockets drag the film through cables (2) to stretch and spin in space. The spin axis points toward the sun. After the rockets stopped jetting, the centrifugal pull keeps pulling cables (2), which connect the rockets to form a frame of regular triangle. The tension of the cables and the centrifugal pull produced by the spin of the film, as well as the solar light pressure keep the film concave mirror stretched and maintain the prefabricated form of a revolutionary paraboloid. In this example, small remote controlled rockets (1) are the weights on the periphery of the concave mirror.

Three small remote controlled rockets (1) are connected separately by control cables (5) of lightweight and high strength to circular ring (7) on load (6). Inside circular ring (7), there mounted the device for cable control. Adjust the length of cables (5) properly to locate the solar energy absorbers (11) on the load to the focal point of the concave mirror. In addition, adjusting the length of cables (5) properly, the direction of the concave mirror can be altered slowly like operating a sweep. However, since the system is at spin, cables (5) must be adjusted periodically with a cycling period equal to that of the spin.

Control rod (8) is mounted on circular ring (7), giving guidance to cables (5) to improve the control over the curved surface of revolution. Thermal radiation plates (9) are fixed on load (6) to dissipate extra heat. The included angles between each two adjacent thermal radiation plates are equal and all plates are in common planes of the central axis line.

### PREFERRED EMBODIMENT 2

Spin-Stretched Film Concave Mirror as Shown in FIG. 3

Six weights (10) of equal mass are connected successively with cables (2) to form a regular hexagon. The edge of the film concave mirror stretches into a plane, which is connected with each side of the hexagon, i.e. cables (2). In the realm of incircle of the hexagon, the film is the revolutionary paraboloid (3); and outside the incircle, the film part (24) is a plane. Circular ring (7) installed on load (6) is used to control cables (5), which are connected respectively with weights (10).

In space, the film concave mirror spins under the pulling of the load or the circular ring. The centrifugal pull produced by spin makes the film stretch out (the spin axis points toward the sun). Under the action of centrifugal pull, the six weights stretch cables (2) at film periphery to open the film, and under the co-action of light pressure of sunrays, the film maintain its prefabricated form of a revolutionary paraboloid.

### PREFERRED EMBODIMENT 3

Ring Form Mirror of Several Different Shapes

Shown in FIG. 4 are the cross-sectional views of different shapes of ring form film mirrors. Arrows show light path of incident sunlight along the axis reflected by the mirror.

FIG. 4A shows the ring form conic mirror, of which the generating line is a strait line (13), included angel of 45° between the generating line and the axis (12). The incident sun light along the axis is reflected by the mirror and converged at the central axis line and is perpendicular to the central axis line.

FIG. 4B presents a ring form arc face mirror, of which the generating line (14) is an arc line extruding outward. The connection line between the two ends of the generating line form an included angle of 45° with the axis. The sun light reflected by the ring form arc-surface concentrates on a shorter axis.

FIG. 4C gives a special example of ring form arc mirror, which is formed by cutting revolutionary paraboloid (15) by plane (17), which is perpendicular to the axis. No matter which two planes cutting the revolutionary paraboloid and forming the ring form mirror, the focus of the mirror is always the focus of the original revolutionary paraboloid, only the focus locations are different in relation with the ring form mirror surface.

### PREFERRED EMBODIMENT 4

Ring Form Mirror with Front and Back Frame

As are shown in FIG. 5, the front and back mouths of the ring form film-mirror (4) are stretched and connected to the two plane hexagons formed by weights (10) and cables (2). The weights (10) on the apexes of the two hexagons are connected respectively by control cables (5) to two rotating pans (16) mounted at two ends of load (6). On the two rotating pans are provided control rod (8) and cable adjusting devices. The two rotating pans are all extend outside mirror mouth planes to exert certain tension on the ring form mirror along the direction of the generating ling. Thermal radiation plates (9) are fixed on load (6) and do not hinder the sun light reflecting from the ring form mirror surface to the load (in this example, solar energy absorbers are mounted on the surface of the load ), while the infrared rays radiated from thermal radiation plates (9) can be reflected through the ring form mirror surface to space. The spin axis of the ring form mirror points toward the sun.

### PREFERRED EMBODIMENT 5

Ring Form Mirror without Frame

As illustrated in FIG. 6, the edge of the ring form mirror face (4) is connected with the peripheral weights (10) directly. The weights on the edge of front and back mouths of the mirror are connected separately by control cables (5) to two rotating pans (16). Each two corresponding weights (10) on the edges of front and back mouth is connected with a cable (2) (of which the length is determined by the width of the ring form mirror). The two rotating pans are also extend outside the planes of the mirror mouths and maintain a certain tension in cables (2), which connect weights (10), so as to keep the width of the ring surface.

In order to strengthen the connection between weights (10) and mirror surface. two circular cables (18) can be added separately on the edge of front and back mouths of the mirror. Cables (18) can be a ribbon form so as to combine better with the film. These cables are also connected with weights (10).

Load (6) at the central axis is a rigid bar, on which solar energy absorber (11) is located at the focal point of the ring form mirror. This kind of ring form mirror is simple in structure and easy to stretch. In order to reduce the volume further before stretching, a contractible sheath structure can be used for the rigid bar. One end of the rigid bar is connected to spacecraft.

### PREFERRED EMBODIMENT 6

Film Concave Mirror with a Bottom of Umbrella Form

As shown in FIG. 7, load (6) of the concave mirror is a rigid bar penetrating the bottom of the mirror. At the joint places of the rigid bar to the mirror bottom and to the mouth plane of the mirror, two rings (7) are mounted separately. On the bottom ring, ribs (20) are installed uniformly, which are hinged onto the bottom ring to facilitate contraction. Between the ribs, there is the canopy (21), which is constructed of reflecting film. The canopy is connected smoothly with peripheral mirror face (3). The edge of mirror mouth is connected with ring form cable (18) and weights (10). Adjust precisely the length of control cables (5), so that to keep revolution radius of weights (10) around the central axis equal to the radius of mirror mouth. For concave mirror of smaller diameter, the umbrella form structure at the bottom of the mirror can also be replaced with a rigid pan.

The above practical application examples combined with the attached figures provide detailed description for this invention. This invention is not limited to these specific application examples. Any variation and modification of technical scheme on the general ideas of this invention does not exceed the scope of general ideas and claims of this invention.

1. The spin-stabilized film mirror consists of a reflecting flexible film, cables, weights, load, wherein the surface of the film mirror is a rotate curved surface, and the edge of the film is connected to multi weights at the periphery of the mirror by cables, the weights are then connected to the load located at mirror axis, the film mirror will be opened by spin and will keep the form of the curved surface with spin axis pointing to the sun.

2. The spin-stabilized film mirror according to claim 1, wherein that the load can be a piece of solar energy power equipment, a satellite, a space station or a solar energy rocket, it can also be a rigid bar or truss, on the load, solar absorbers are installed at the focal point of the film mirror, and also installed is a cable adjusting device and a control rod, which are used to adjust and control the length of the cables so as to place the solar absorbers on the load at the focal point of the concave mirror.

3. The spin-stabilized film mirror according to claim 1, on the load a circular ring can be installed, the axis of the circular ring is the same axis as that of the rotate mirror surfacel,the circular ring is connected by the control cables to the weights respectively on the periphery of the concave mirror, the adjusting device of the cables and the control rod are installed on the circular ring, which spins synchronously with the film concave mirror, several thermal radiation plates can be installed on the shell of the load, the plates are coplanar with the axis of the mirror surface.

4. A spin-stabilized film mirror according to claim 1, wherein the mirror can be a concave mirror consisting of a paraboloid of revolution spherical surface, or other curved surface of revolution, and also can be a circular mirror consisting of a circular cone, a circular arc surface, the generating line of the circular cone is a straight line with an included angle of 45° to the mirror axis, the generating line of the circular arc surface is an arc line, which can be a section of a paraboloid curve.

5. A spin-stabilized film mirror according to claim 1, wherein the edge of the mirror can stretch out to be connected to each side of the polygon formed by the cables and the weights, the weights are connected to the vertexes of the polygon.

6. A spin-stabilized film mirror according to claim 1, wherein the edge of the mirror is connected directly with the weights, which revolve around the axis of the mirror under the restrain of the control cables, the revolution diameter of the weights equals to the diameter of mirror edge, the mirror edge can be strengthened with ribbon cables.

7. A spin-stabilized film mirror according to claim 4, wherein the weights on the peripheral edge of the film concave mirror can be remote controlled rockets, which, when in space, pull the film concave mirror to stretch out and to spin in the plane perpendicular to the sun light.

8. A spin-stabilized film mirror according to claim 7, wherein the three remote controlled rockets (1) are connected by cables (2), forming a regular triangle, at the center of the film is the paraboloid of revolution (3), of which the edge stretches out, forming a plane and connecting to the three sides of the regular triangle, circular ring (7) is mounted on load (6) and connected to remote controlled rockets (1) by controlling cables (5), and on circular ring (7), the cable adjusting device and control rod (8) are mounted, thermal radiation plates (9) are fixed on the exterior side of load (6).

9. A spin-stabilized film mirror according to claim 4, wherein multiple weights (10) of the same mass can be connected by cables (2) to form a regular polygon, at the center of the film is the paraboloid of revolution (3), of which the edge stretches out, forming a plane and connecting to the sides of the regular polygon, circular ring (7) on load (6) drives the control cables and weights as well as the film to spin and stretch out and to maintain the form of paraboloid of revolution.

10. A spin-stabilized film mirror according to claim 4, wherein the front and back edges of circular mirror (4) are all stretch out to be connected to two front and back polygons formed by weights (10) and cables (2), weights (10) at polygon vertexes are connected by control cables (5) to two rotating pans (16) mounted on the two ends of load (6), the two rotating pans are all stretched outside the mirror mouth planes, thermal radiation plates (9) are fixed on load (6).

11. A spin-stabilized film mirror according to claim 4, wherein the front and back edges of circular mirror (4) are connected with weights (10) directly, and the weights are then connected by control cables (5) respectively to two rotating pans (16) at the two ends of load (6), the two rotating pans are all stretch out of the mirror mouth planes, the weights (10) at corresponding locations of front and back mouths of the mirror can be connected with cables (2), of which the length is equal to the width of the circular mirror face.

12. A spin-stabilized film mirror according to claim 4, wherein the bottom of the concave mirror is a structure of an umbrella form with the ribs (22) hinges to circular ring (7) on the load, the ribs can be drawn in, the rim of umbrella face (23) is connected smoothly with paraboloid of revolution (3), the bottom of the concave mirror can also be a structure of a rigid pan, of which the rim is connected with mirror face (3).

13. A spin-stabilized film mirror according to claim 1, wherein the weights can be spherical form, pie, or bar-type, in the circular mirror, bar-type weights (19) can be adopted to connect the ends of corresponding control cables (5) at front and back mouths of the mirror, the bar-type weights coincide with the generating line of the mirror face and connected closely with mirror face, the memory alloy or a folding structure capable of automatic stretching can be used for the bar-type weights.

14. A spin-stabilized film mirror according to claim 1, wherein the spin-stabilized film mirror can be used as the radio antenna for a spacecraft, the film mirror of a large area can be used as a solar sail, of which the mirror face can be a concave surface or a plane.

15. A solar energy power generation system using spin-stabilized film mirror, wherein this system can be connected by electric cable to a high orbit spacecraft, roving at the back side of the spacecraft towards the sun, forming a moored solar power station.
